(19) United States
(12) Patent Application Publication
(10) Pub. No.: US 2026/0235086 A1
(43) Pub. Date: Aug. 13, 2026

(54) Method for Operating an Internal Combustion Engine of a Motor Vehicle, in Particular a Car

(71) Applicant: Bayerische Motoren Werke Aktiengesellschaft, Muenchen (DE)

(72) Inventors: Florian DEININGER, Krumbach (DE); Nikita KLEINE, Ismaning (DE); Georg MEDER, Muenchen (DE); Raquel RUIZ GONZALEZ, Muenchen (DE)

(21) Appl. No.: 19/148,846

(22) PCT Filed: Jan. 16, 2024
(86) PCT No.: PCT/EP2024/050894

§ 371 Date: Jul. 17, 2025

(30) Foreign Application Priority Data
Feb. 9, 2023 (DE) 10 2023 103 101.5

(51) Int. Cl. F02D 41/02

(52) U.S. Cl. CPC F02D 41/0235; F02D 41/0295; F02D 41/1446; F02D 41/1458; F02D 41/1462; F02D 41/1465; F02D 2041/1433; F02D 2200/101; F02D 2250/26

(57) ABSTRACT

A method for operating an internal combustion engine having an exhaust gas section and an exhaust gas aftertreatment device by way of which aftertreatment of the exhaust gas is carried out, wherein at least one raw emissions value is calculated on the basis of a first computing model, which raw emissions value characterizes raw emissions of the internal combustion engine. At least one final emissions value is calculated in a manner which is dependent on the raw emissions value on the basis of a second computing model, which final emissions value characterizes emissions which result from the raw emissions and the aftertreatment of the exhaust gas, leave the exhaust gas section, and are output to a surrounding area of the motor vehicle. The internal combustion engine is operated in a manner which is dependent on the final emissions value.

### BACKGROUND AND SUMMARY

This disclosure relates to a method for operating an internal combustion engine of a motor vehicle, in particular a car.

DE 10 2016 014 854 A1 discloses a method for exhaust gas aftertreatment for an internal combustion engine. DE 10 2010 002 620 A1 also discloses a method for operating an SCR catalytic converter for aftertreatment of exhaust gases from an internal combustion engine.

Furthermore, motor vehicles with internal combustion engines are known from the general prior art and, in particular, from the series production of vehicles, wherein the respective internal combustion engine comprises an exhaust gas tract, through which exhaust gas from the internal combustion engine can flow, and an exhaust gas aftertreatment device which is arranged in the exhaust gas tract and by way of which the exhaust gas undergoes aftertreatment.

The object of the present disclosure is to provide a method for operating an internal combustion engine of a motor vehicle such that particularly low-emission operation can be realized.

The disclosure relates to a method for operating an internal question engine, also referred to as engine or combustion engine, of a motor vehicle, also referred to simply as vehicle, which is preferably in the form of a car, in particular a passenger car. In particular, provision is made for the motor vehicle to be driven by way of the internal combustion engine in the method or during the method. Provision is very particularly made for the method to be carried out during fired operation of the internal combustion engine such that the internal combustion engine is preferably operated in fired operation during the method, thus is operated in a fired manner. The internal combustion engine comprises at least one combustion chamber in which combustion processes are carried out during fired operation of the internal combustion engine. In the respective combustion process, a fuel/air mixture, also referred to simply as mixture, is ignited and combusted, wherein the mixture comprises an, in particular liquid, fuel and load. In particular, for example, the internal combustion engine is in the form of an Otto engine such that, for example, the fuel is an Otto fuel, thus gasoline. In this case, for example, the mixture is ignited via applied ignition and thus by way of an ignition device, in particular by virtue of at least one ignition spark for igniting the mixture being produced by way of the ignition device.

The internal combustion engine comprises an exhaust gas tract, through which exhaust gas from the internal combustion engine can flow. The exhaust gas originates, for example, from the combustion chamber and results from the combustion of the mixture, thus from the respective combustion process. The internal combustion engine also comprises an exhaust gas aftertreatment device which is arranged in the exhaust gas tract and by way of which the exhaust gas undergoes aftertreatment. The aftertreatment of the exhaust gas is to be understood as meaning, in particular, that first components contained in the exhaust gas can be converted into second components, different from the first components, by way of the exhaust gas aftertreatment device. For this purpose, for example, the exhaust gas aftertreatment device comprises at least or precisely one catalytic converter, which may be in the form of a three-way catalytic converter, for example.

In order to now be able to realize particularly low-emission operation of the internal combustion engine and thus of the motor vehicle overall, provision is made according to the disclosure, in particular during fired operation of the internal combustion engine, for at least one raw emissions value to calculated by way of an electronic computing device, in particular of the motor vehicle and very particularly the internal combustion engine, on the basis of a first computing model, also referred to as raw emissions model, which is stored in an, in particular electrical or electronic, data storage medium of the electronic computing device, which raw emissions value characterizes raw emissions of the internal combustion engine. As is already known from the general prior art, the raw emissions of the internal combustion engine are to be understood as meaning emissions contained in the exhaust gas before the exhaust gas flows through the exhaust gas aftertreatment device, thus before the exhaust gas undergoes aftertreatment by way of the exhaust gas aftertreatment device. The exhaust gas therefore comprises the raw emissions in an untreated state of the exhaust gas, which is in its untreated state in the combustion chamber and before the exhaust gas undergoes aftertreatment by way of an exhaust gas aftertreatment device.

Furthermore, provision is made in the method according to the disclosure for at least one final emissions value to be calculated by way of the electronic computing device using a second computing model which is stored in the data storage medium and in particular is provided in addition to the first computing model, in a manner dependent on the raw emissions value, in particular from the raw emissions value, which final emissions value characterizes emissions which result from the raw emissions and the aftertreatment of the exhaust gas effected by way of the exhaust gas aftertreatment device, leave the exhaust gas tract, and are output to a surrounding area of the motor vehicle overall. For example, the exhaust gas tract, also referred to as exhaust gas system, opens into or to the surrounding area via at least or exactly one outflow opening, wherein the exhaust gas flows through the outflow opening and as a result flows out of the exhaust gas tract and into or to the surrounding area of the motor vehicle overall. In particular, for example, the outflow opening is formed by a tailpipe of the exhaust gas system, thus an opening of a tailpipe of the exhaust gas system. The emissions characterized by the final emissions value are also referred to as final emissions or tailpipe emissions. The final emissions are to be understood as meaning emissions which flow out of the exhaust gas tract and flow to or into the surrounding area of the motor vehicle overall, thus are output by the motor vehicle to the surrounding area thereof.

Furthermore, provision is made in the method according to the disclosure for the internal combustion engine to be operated in a manner dependent on the final emissions value, in particular during fired operation thereof. The internal combustion engine can thus be operated in a manner dependent on the final emissions value, for example, such that the final emissions value or the final emissions do not exceed a, for example predefinable or predefined, threshold, that is to say they fall below same and/or an exceeding of the threshold by the final emissions value or by the final emissions can be counteracted, such that the threshold can be exceeded by the final emissions value or the final emissions only briefly. This can thus ensure particularly low-emission operation of the internal combustion engine. In particular, the method according to the disclosure makes it possible to calculate the final emissions value or the final emissions and to thereby monitor same. The background of the disclosure is, in particular, that sensor-based, in particular purely sensor-based, monitoring of the final emissions is not possible or is possible only with a great degree of complexity. In contrast, the method according to disclosure enables model-based calculation and thus determination of the final emissions, as a result of which the final emissions value or the final emissions can be determined quickly and precisely. The method according to the disclosure also makes it possible to operate the internal combustion engine in a manner dependent on the final emissions value so that, for example, it is possible to prevent the final emissions valne or the final emissions from exceeding a limit value. In particular, the method according to the disclosure is an emissions observer.

For example, the second computing model is also referred to as a catalytic converter model, in particular when the exhaust gas aftertreatment device comprises the aforementioned catalytic converter. For example, the computing models overall are or form a physiochemical model which can be used to quickly and precisely calculate the final emissions value and thus the final emissions of the internal combustion engine. In particular, the raw emissions are emissions which occur due to or during the combustion of the respective mixture and which can advantageously be calculated by the first computing model. For example, the second computing model can be used to calculate and thus determine a converting ability of the exhaust gas aftertreatment device, in particular the catalytic converter, as a result of which the second computing model can be used to quickly and precisely calculate the final emissions value in a manner dependent on the raw emissions value.

The background of the disclosure is, in particular, that final emissions may exceed a level in dynamic driving situations in which, for example, accelerations up to a maximum possible maximum speed of the motor vehicle occur, despite a maximum possible aftertreatment of the exhaust gas by the exhaust gas aftertreatment device. Sensor-based, in particular purely sensor-based, determination of the final emissions is not possible or is possible only with a great deal of complexity, in particular to the extent that such determination of the final emissions is too passive and thus too slow. In contrast, the method according to the disclosure makes it possible to quickly and precisely calculate the final emissions that the internal combustion engine can be operated in a manner dependent on the final emissions value, for example, in such a way that exceeding of the level, also referred to as limit or limit value or in the form of a limit or limit value, by the final emissions can be prevented.

In order to be able to ensure particularly low-emission, provision is made in one advantageous configuration of the disclosure for the internal combustion engine to be operated in a manner dependent on the final emissions value in such a that a maximum load that can be provided by the internal combustion engine for driving the motor vehicle is restricted to a limit value. The load is or corresponds to a torque that can be provided by the internal combustion engine, in particular, via the drive shaft thereof in the form of a crankshaft, for example, for driving the motor vehicles so that, for example, provision is preferably made for the maximum torque that can be provided by the internal combustion engine, in particular via the drive shaft thereof, for driving the motor vehicle to be restricted to the limit value. This can advantageously keep the raw emissions, also referred to as exhaust gas for emissions, low and increases the converting ability of the exhaust gas aftertreatment device so that exceeding of the level by the final emissions can be prevented.

It has been shown to be particularly advantageous that a value of the maximum load that can be provided by the internal combustion engine or the maximum torque that can be provided by the internal combustion engine for driving the motor vehicle that is greater than the limit value is permitted during operation of the internal combustion engine that precedes the restriction of the load and/or during operation of the internal combustion engine following the restriction of the load. This means that restriction of the maximum load that can be provided by the internal combustion engine for driving the motor vehicle is understood as meaning that the maximum load that can be provided by the internal combustion engine for driving the motor vehicle is reduced, in particular temporarily, with respect to the operation of the internal combustion engine preceding the restriction and/or following the restriction, as a result of which particularly low-emission operation of the internal combustion engine and thus of the motor vehicle overall can be ensured.

Another embodiment is characterized in that the final emissions value is compared with a predefined threshold value by way of the electronic computing device, wherein the maximum load that can be provided by the internal combustion engine for driving the motor vehicle is restricted to the limit value when the comparison reveals that the final emissions value exceeds the predefined threshold value. As a result, exceeding of the aforementioned level by the final emissions can be prevented reliably and, in particular, predictively, that is to say in advance. In other words, it is thereby possible to restrict the load of the internal combustion engine when and in particular as early as before the end emissions actually exceed the level. This can ensure particularly low-emission operation.

The restriction of the load to the limit value is a possible fallback reaction carried out in a manner dependent on the final emissions value, in particular as a reaction to the final emissions value. As an alternative or in addition, the fallback reaction carried out in a manner dependent on the final emissions value may be a reaction or measure comprising, for example, varying a combustion air ratio, also referred to as lambda, and/or an air/fuel mixture and/or varying control times, in particular valve control times and/or inlet and/or outlet spread, and/or varying a fuel injection, in particular with respect to various modes such as, for example, double, single, direct and/or intake pipe injection. As an alternative or in addition, the fallback reaction may comprise varying an engine speed and/or restricting same to a maximum speed value and/or varying an engine power of the internal combustion engine and/or restricting same to a maximum value.

In order to be able to calculate the raw emissions value particularly quickly and precisely, another configuration of the disclosure makes provision for the raw emissions value to be calculated using the first computing model in a manner dependent on a or the load and a speed of the internal combustion engine.

Another embodiment is characterized in that the raw emissions value is calculated using the first computing model in a manner dependent on a combustion air ratio of the internal combustion engine, the combustion air ratio also being denoted by lambda or by the Greek lower case λ. The raw emissions value can therefore be calculated particularly quickly and precisely so that, as a result, the final emissions value can be calculated precisely.

In another particularly advantageous embodiment of the disclosure, provision is made for the second computing model to be used to calculate an ability of the exhaust gas aftertreatment device to convert first components included in the exhaust gas into second components, different from the first components, through the aftertreatment of the exhaust gas, wherein the ability in this case is the aforementioned converting ability, for example. The final emissions value is calculated here in a manner dependent on the calculated ability. As a result, the final emissions value can be calculated quickly and precisely so that the internal combustion engine can particularly advantageously be operated in a manner dependent on the final emissions value. Particularly low-emission operation can thus be ensured.

Another embodiment is characterized in that the final emissions value is calculated using the second computing model in a manner dependent on at least one temperature of the exhaust gas aftertreatment device, by way of which the final emissions value can be calculated quickly and precisely.

It has been shown to be particularly advantageous for implementing a particularly precise and quick calculation of the final emissions value if the temperature is measured by way of a temperature sensor of the internal combustion engine.

Finally, it has been shown to be particularly advantageous if the final emissions value is calculated using the second computing model in a manner dependent on an amount of oxygen stored in the exhaust gas aftertreatment device and/or in a manner dependent on a velocity with which the exhaust gas flows through the exhaust gas aftertreatment device, the velocity being in the form, in particular, of a space velocity. As a result, the final emissions value can be calculated particularly precisely so that particularly low-emission operation can be realized.

Further details of the disclosure will become apparent from the description below of a preferred exemplary embodiment with the associated drawing.

### BRIEF DESCRIPTION OF DRAWING

FIG. 1 shows a schematic illustration of an internal combustion engine of a motor vehicle.

### DETAILED DESCRIPTION OF DRAWING

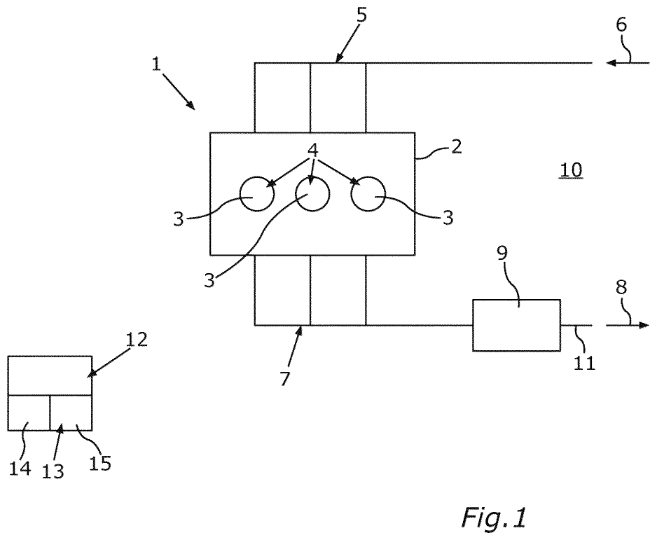

FIG. 1 shows a schematic illustration of an internal combustion engine 1, also referred to as engine or combustion engine, of a motor vehicle, also referred to simply as vehicle, which can be driven, in particular is driven, by way of the internal combustion engine 10. The following text describes a method for operating the internal combustion engine 1 of the motor vehicle with reference to FIG. 1. Provision is made here, in particular, for the internal combustion engine 1 to be operated in fired operation during the method. The internal combustion engine 1 comprises a housing element 2 which is, for example, a cylinder housing, in particular a cylinder crank housing. The housing element 2 comprises multiple cylinders 3. A respective combustion chamber 4 of the internal combustion engine 1 is partly delimited by the respective cylinder 3. A respective piston of the internal combustion engine 1 is held in the respective cylinder 3 so as to be able to move in a translatory manner, wherein the respective combustion chamber 4 is delimited partly by the respective cylinder 3 and partly by the respective piston. The internal combustion engine 1 is therefore, for example, in the form of a reciprocating piston machine, thus a reciprocating piston engine.

The internal combustion engine I comprises an intake tract 5, also referred to as an inlet tract, through which air can flow. An arrow 6 illustrates that the air, also referred to as fresh air, flows through the intake tract 5. The air flowing through the intake tract 5 to and into the combustion chambers 4 is directed by way of the intake tract 5. A respective fuel/air mixture, which is also referred to simply as mixture, is formed within a respective cycle of the internal combustion engine 1 preferably in the form of a four-stroke engine in the respective combustion chamber 4. The respective mixture comprises the mentioned air and a preferably liquid fuel. The internal combustion engine 1 is preferably an Otto engine, thus a gasoline engine, and so the fuel is preferably an Otto fuel, thus gasoline. The mixture is combusted in the respective combustion chamber 4 within the respective cycle, which results in exhaust gas from the internal combustion engine 1. The internal combustion engine I comprises an exhaust gas tract 7, which is also referred to as exhaust gas system, through which exhaust gas from the combustion chambers 4 can flow. FIG. 1 illustrates by way of an arrow 8 the fact that the exhaust gas flows through the exhaust gas tract 7. The internal combustion engine 1 comprises an exhaust gas aftertreatment device 9 which is arranged in the exhaust gas tract 7 and which in the present case is the only exhaust gas aftertreatment device of the internal combustion engine 1 designed for aftertreatment of the exhaust gas. In the method, the exhaust gas flowing through the exhaust gas tract 7 and thus the exhaust gas aftertreatment device 9 undergoes aftertreatment by way of the exhaust gas aftertreatment device 9. Provision is made, in particular, for the exhaust gas aftertreatment device 9 to comprise all of the exhaust gas aftertreatment components of the internal combustion engine 1, in particular of the motor vehicle overall, designed for aftertreatment of the exhaust gas so that exhaust gas can undergo aftertreatment and does undergo aftertreatment in relation to the motor vehicle as a whole only using the exhaust gas aftertreatment device 9.

It can be identified from the arrow 8 that the exhaust gas system (the exhaust gas tract 7) opens to a surrounding area 10 of the motor vehicle via at least or precisely one outflow opening. The outflow opening is formed, for example, by the tailpipe 11 of the exhaust gas tract 7 so that, for example, the exhaust gas flows through the tailpipe 11 as the last component of the motor vehicle on its way through the exhaust gas tract 7 to or into the surrounding area 10. The exhaust gas flows through the outlet opening on its way into or to the surrounding area 10, wherein the exhaust gas flowing through the outflow opening flows out of the exhaust gas tract 7 and into or to the surrounding area 10.

In the respective combustion chamber 4 and in the exhaust gas tract 7 upstream of the exhaust gas aftertreatment device 9, the exhaust gas comprises raw emissions which are formed by first components contained in the exhaust gas. The raw emissions comprise, for example, carbon monoxide emissions (CO emissions) and/or non-combusted hydrocarbons (HC) and/or nitrogen oxide emissions (NOx emissions). In the tailpipe 11 and thus downstream of the exhaust gas aftertreatment device 9, the exhaust gas comprises final emissions which result, for example, from the aftertreatment of the exhaust gas effected by way of the exhaust gas aftertreatment device 9 and from the raw emissions. In the aftertreatment of the exhaust gas, at least some, thus at least a portion, of the first components are converted, for example, by way of the exhaust gas aftertreatment device 9 into second components, different from the first components, such that, for example, the final emissions comprise the second components and possibly a portion of the first components not converted by the exhaust gas aftertreatment device 9.

In order to now be able to realize particularly low-emission operation of the internal combustion engine 1 and thus of the motor vehicle overall, in particular during fired operation of the internal combustion engine 1, at least one raw emissions value is calculated by way of an electronic computing device 12 of the motor vehicle, in particular of the internal combustion engine 1 using a first computing model 14 which is stored in a data storage medium 13 of the electronic computing device 12, which raw emissions value characterizes raw emissions of the internal combustion engine 1. The electronic computing device 12 may comprise a processor, controller, or the like configured to execute software, logic, and/or instructions stored on the data storage medium 13, which may comprise a memory. Furthermore, at least one final emissions value is calculated by way of the electronic computing device 12 using a second computing model 15 which is stored in the data storage medium 13 and, in particular, is provided in addition to the first computing model 14, in a manner dependent on the raw emissions value, which final emissions value characterizes, that is to say describes or indicates, final emissions, also referred to simply as emissions, which result from the raw emissions and the aftertreatment of the exhaust gas, leave the exhaust gas tract 7, and are output to a surrounding area 10 of the motor vehicle overall. Provision is also made for the internal combustion engine 1 to be operated by way of the electronic computing device 12 in a manner dependent on the calculated final emissions value, in particular in such a way that a maximum load or torque that can be provided by the internal combustion engine 1 for driving the motor vehicle is restricted to a limit value temporarily and thus at least during a first period of time. For example, provision is made for a value of the maximum load or torque that can be provided by the internal combustion engine 1 for driving the motor vehicle that is greater than the limit value to be permitted during a second period of time preceding the first period of time and/or during a third period of time following the first period of time period of time, so that the maximum load that can be provided by the internal combustion engine 1 for driving the motor vehicle is lower during the first period of time than during the second period of time and is lower than during the third period of time. This can prevent the final emissions from exceeding a level, for example formed as a limit or limit value, so that particularly low-emission operation of the internal combustion engine 1 and thus of the motor vehicle overall can be ensured.

For example, the second computing model calculates for multiple volume elements, for example volume elements arranged next one another or consecutively, for example volume discs, of the exhaust gas aftertreatment device 9 a respective ability, also referred to as converting ability, for converting final components contained in the exhaust gas upstream of the exhaust gas aftertreatment device 9 into the second components, different from the first components. Provision is made here, in particular, for the volume elements to be consecutive, for example, in the flow direction of the exhaust gas flowing through the exhaust gas aftertreatment device 9. The final emissions which can be determined quickly and precisely by calculating the final emissions value by way of the method result from the conversion of the first components into the second components effected by the volume elements. As a result, for example, the internal combustion engine I can be operated in an anticipatory manner and thus predictively in such a way that exceeding of the level by the final emissions is prevented. This is carried out, for example, in such a way that, if the electronic computing device 12 ascertains that the final emission value exceeds a predefined threshold value, the maximum load that can be provided by the internal combustion engine 1 for driving the motor vehicle is restricted. This makes it possible to prevent the final emissions from exceeding the level.

### LIST OF REFERENCE SIGNS

1 Internal combustion engine
2 Housing element
3 Cylinder
4 Combustion chamber
5 Intake tract
6 Arrow
7 Exhaust gas tract
8 Arrow
9 Exhaust gas aftertreatment device
10 Surrounding area
11 Tailpipe
12 Electronic computing device
13 Data storage medium
14 First computing model
15 Second computing model

1.-10. (canceled)

11. A method for operating an internal combustion engine of a motor vehicle, in which the internal combustion engine has an exhaust gas tract, through which exhaust gas from the internal combustion engine can flow, and an exhaust gas aftertreatment device which is arranged in the exhaust gas tract and by way of which the exhaust gas undergoes aftertreatment, the method comprising:
calculating at least one raw emissions value by way of an electronic computing device using a first computing model which is stored in a data storage medium of the electronic computing device, which raw emissions value characterizes raw emissions of the internal combustion engine;
calculating at least one final emissions value by way of the electronic computing device in a manner dependent on the raw emissions value and using a second computing model which is stored in the data storage medium, which final emissions value characterizes emissions which result from the raw emissions and the aftertreatment of the exhaust gas, leave the exhaust gas tract, and are output to a surrounding area of the motor vehicle; and
operating the internal combustion engine in a manner dependent on the final emissions value.

12. The method according to claim 11, wherein
the internal combustion engine is operated in a manner dependent on the final emissions value in such a way that a maximum load that can be provided by the internal combustion engine for driving the motor vehicle is restricted to a limit value.

13. The method according to claim 12, wherein
a value of the maximum load that can be provided by the internal combustion engine for driving the motor vehicle that is greater than the limit value is permitted during operation of the internal combustion engine that precedes the restriction of the load and/or during operation of the internal combustion engine following the restriction of the load.

14. The method according to claim 12, wherein
the final emissions value is compared with a predefined threshold value by way of the electronic computing device, wherein the maximum load that can be provided by the internal combustion engine for driving the motor vehicle is restricted to the limit value when the comparison reveals that the final emissions value exceeds the predefined threshold value.

15. The method according to claim 11, wherein
the raw emissions value is calculated using the first computing model in a manner dependent on a load and a speed of the internal combustion engine.

16. The method according to claim 11, wherein
the raw emissions value is calculated using the first computing model in a manner dependent on a combustion air ratio of the internal combustion engine.

17. The method according to claim 11, wherein
the second computing model is used to calculate an ability of the exhaust gas aftertreatment device to convert first components included in the exhaust gas into second components, different from the first components, through the aftertreatment of the exhaust gas, wherein the final emissions value is calculated in a manner dependent on the calculated ability.

18. The method according to claim 11, wherein
the final emissions value is calculated using the second computing model in a manner dependent on at least one temperature of the exhaust gas aftertreatment device.

19. The method according to claim 18, wherein
the temperature is measured by way of a temperature sensor of the internal combustion engine.

20. The method according to claim 11, wherein
the final emissions value is calculated using the second computing model in a manner dependent on an amount of oxygen stored in the exhaust gas aftertreatment device and/or in a manner dependent on a velocity with which the exhaust gas flows through the exhaust gas aftertreatment device.
